(19) United States
(12) Patent Application Publication
(10) Pub. No.: US 2006/0169955 A1
(43) Pub. Date: Aug. 3, 2006

(54) Tail block assembly with multi-axis swivel joint and tail block system comprising same

(76) Inventor: Kenneth Matthew Simonsen, Rim Rock, AZ (US)

Correspondence Address: David O. Simmons;Galasso & Associates LP, P.O. Box 26503, Austin, TX, 78755-0503, US

(21) Appl. No.: 11/237,308

(22) Filed: Sep. 27, 2005

Related U.S. Application Data
(60) Provisional application No. 60/613,570, filed on Sep. 27, 2004.

(51) Int. Cl. B25B 25/00

(52) U.S. Cl. 254/200

(57) ABSTRACT

A tail block assembly for a carpet stretching apparatus comprises a tail block mounting structure, a displacement device engaging structure and a multi-axis swivel joint. The multi-axis swivel joint includes a first yoke structure fixedly attached to the displacement device engaging structure, a second yoke structure fixedly attached to the tail block mounting structure and a linkage member pivotably connected between the first yoke structure and the second yoke structure. The first yoke structure pivots about a first pivot axis of the linkage member and the second yoke structure pivot about a second pivot axis of the linkage member. The first pivot axis extends approximately perpendicularly through the second pivot axis. The first pivot axis extends approximately perpendicular with respect to a longitudinal reference axis of the displacement device engaging structure and the second pivot axis extends approximately perpendicular with respect to a longitudinal reference axis of the tail block mounting structure.

### CROSS REFERENCE TO RELATED APPLICATIONS

This patent application claims priority to co-pending United States Provisional Patent Application having Ser. No. 60/613,570 filed Sep. 27, 2004 entitled “Profiler”, having a common applicant herewith and being incorporated herein in its entirety by reference.

### FIELD OF THE DISCLOSURE

The disclosures made herein relate generally to carpet stretching apparatuses and, more particularly, to devices configured for anchoring an end of a carpet stretching apparatus to a relatively immovable structure such as, for example, a wall, railing, etc.

### BACKGROUND

In performing the installation of wall-to-wall carpeting, the need for the carpet to be physically stretched into position is well known. Stretching of the carpeting tensions the installed carpet thereby reducing or eliminating wrinkling in the carpet. A first edge of the carpet is engaged with a retaining strip (e.g., a tack strip) secured to the flooring adjacent a first region (e.g., a first wall) of the room. Any number of conventional carpet stretching apparatuses are used to stretch the carpet from the retaining strip adjacent the first region of the room toward a second region (e.g., a second wall) of the room. Once sufficiently stretched, a second edge of the carpet adjacent the second region of the room (e.g., an opposite edge of the carpet) is engaged with a retaining strip secured to the flooring adjacent the second region of the room.

A preferred type of carpet stretching apparatus employs a tail block, a carpet gripping head and a displacement device. The displacement device is connected between the tail block and the carpet gripping head. The displacement device is configured for displacing the carpet gripping head with respect to the tail block along a longitudinal reference axis of the displacement device. Such displacement is accomplished through application of force generated using mechanical, pneumatic, hydraulic, electro-magnetic and/or other known force generating means.

In use, an installer positions the tail block against an immovable structure in a room (e.g., a wall) adjacent a first edge of a carpet secured to a retaining strip and engages the carpet gripping head with the carpet at second region of the room. The displacement device is then energized for displacing the carpet gripping head with respect to the tail block. In doing so, the carpet extending between the carpet gripping head and the tail block is stretched. While in the stretched configuration, the second edge of the carpet is engaged with a retaining strip adjacent the second region of the room. This process is repeated across a width of a piece of carpet for stretching the entire piece of carpet.

During use, it is common for the longitudinal reference axis of the displacement device to be slightly to moderately skewed (i.e., non-perpendicular) with respect to an engaged immovable structure. Such skewed engagement with the immovable structure can result in damage of the immovable structure and/or the carpet stretching apparatus as a result of the tail block slipping from position while the displacement device applies force. This possibility for slippage and/or damage is amplified in cases where the tail block has no or limited self-alignment capability for enabling its engagement surface to achieve flush engagement with the immovable structure. The skewed orientation and limited self-alignment capability results in more point-specific application of force which greatly increases pressure and stress on the point or points of contact with the immovable structure.

Therefore, a tail block assembly that overcomes shortcoming associated with conventional tail blocks and carpet stretching apparatuses would be useful and advantageous.

### SUMMARY OF THE DISCLOSURE

Embodiments of the present invention enable a carpet stretching apparatus to be operated in a more consistent, safer and less damaging manner. More specifically, embodiments of the present invention reduce adverse situations arising from a carpet stretching apparatus being engaged with an immovable structure in a skewed manner. Furthermore, embodiments of the present invention provide for more uniform and lower pressure being applied by a tail block of a carpet stretching apparatus on the immovable structure (e.g., a baseboard). In doing so, embodiments of the present invention advantageously overcome shortcoming associated with conventional tail blocks and carpet stretching apparatuses.

In one embodiment of the present invention, a tail block assembly for a carpet stretching apparatus comprises a tail block mounting structure, a displacement device engaging structure and a multi-axis swivel joint. The multi-axis swivel joint is connected between the tail block mounting structure and the displacement device engaging structure. The multi-axis swivel joint enables the displacement device engaging structure to pivot with respect to the tail block mounting structure about two approximately perpendicular pivot axes.

In another embodiment of the present invention, a tail block assembly for a carpet stretching apparatus comprises a tail block mounting structure, a displacement device engaging structure and a multi-axis swivel joint. The multi-axis swivel joint includes a first yoke structure fixedly attached to the displacement device engaging structure, a second yoke structure fixedly attached to the tail block mounting structure and a linkage member pivotably connected between the first yoke structure and the second yoke structure. The first yoke structure pivots about a first pivot axis of the linkage member and the second yoke structure pivot about a second pivot axis of the linkage member. The first pivot axis extends approximately perpendicularly through the second pivot axis. The first pivot axis extends approximately perpendicular with respect to a longitudinal reference axis of the displacement device engaging structure and the second pivot axis extends approximately perpendicular with respect to a longitudinal reference axis of the tail block mounting structure.

In another embodiment of the present invention, a tail block system comprises a plurality of tail blocks and a multi-axis swivel joint assembly. Each one of the tail blocks has a swivel joint attachment structure and an engagement face having a respective unique profile. The multi-axis swivel joint assembly includes a tail block mounting structure, a displacement device engaging structure and a multi-axis swivel joint. The tail block mounting structure is configured for being securely engaged with the swivel joint attachment structure of each one of the tail blocks. The displacement device engaging structure is configured for being engaged with a displacement device of a carpet stretching apparatus. The multi-axis swivel joint is connected between the tail block mounting structure and the displacement device engagement structure. The multi-axis swivel joint enables the displacement device engaging structure to pivot with respect to the tail block attachment structure about two approximately perpendicular pivot axes.

Turning now to specific aspects of the present invention, in at least one embodiment, a tail block is attached to the tail block mounting structure.

In at least one embodiment of the present invention, the tail block includes an engagement face having a contoured profile.

In at least one embodiment of the present invention, the contoured profile includes at least one step formation extending linearly across an entire width of the tail block.

In at least one embodiment of the present invention, a plurality of tail blocks are provided with the contoured profile of a first one of the tail blocks includes at least one step formation extending linearly across an entire width thereof and the contoured profile of a second one of the tail blocks includes at least two step formations extending linearly across an entire width thereof.

In at least one embodiment of the present invention, the tail block mounting structure is engaged with a mounting plate of the tail block, a tail block mounting member extends through the mounting plate and the tail block mounting member is accessible through an opening in the engagement face.

In at least one embodiment of the present invention, the tail block includes a compliant layer of material attached to the engagement face.

In at least one embodiment of the present invention, the multi-axis swivel joint has a first end portion attached to the displacement device engagement structure and a second end portion attached to the tail block mounting structure, a first pivot axis extends through a longitudinal reference of the displacement device engagement structure, a second pivot axis extends through a longitudinal reference axis of the tail block mounting structure and the first pivot axis extends approximately perpendicularly through the second pivot axis.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts an embodiment of a tail block assembly in accordance with the present invention.

FIG. 2 is a partially exploded and cross-sectional side view of the tail block assembly depicted in FIG. 1.

FIG. 3 depicts an embodiment of a tail block system in accordance with the present invention.

### DETAILED DESCRIPTION OF THE DRAWING FIGURES

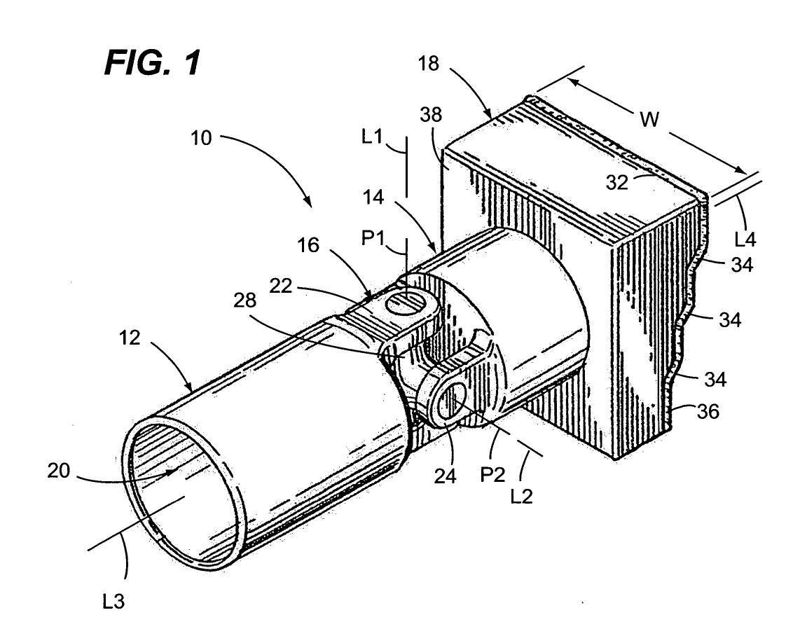

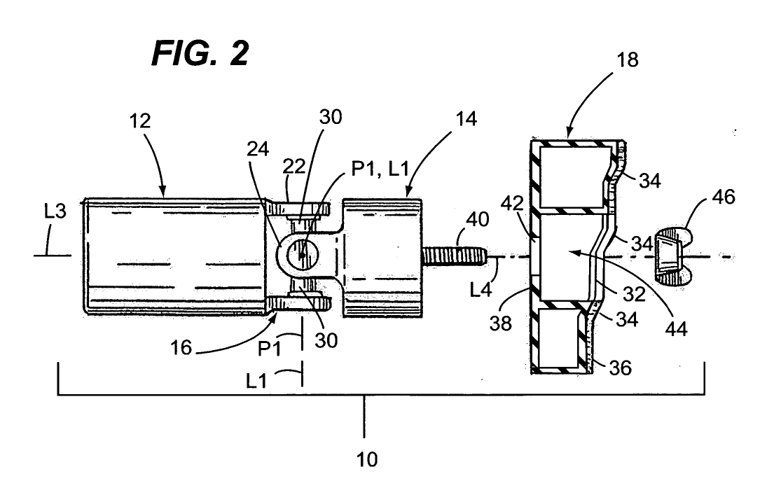

FIGS. 1 and 2 depict an embodiment of a tail block assembly in accordance with the present invention, which is referred to herein as the tail block assembly 10. The tail block assembly 10 is configured for and intended for use with a carpet stretching apparatus. As will be appreciated in view of the ensuing disclosure, the tail block assembly 10 embodies the advantages, utility and overall construction of a tail block assembly in accordance with the present invention.

The tail block assembly 10 includes a displacement device engaging structure 12, a tail block mounting structure 14, a multi-axis swivel joint 16 (i.e., the swivel joint 16) and a tail block 18. The displacement device engaging structure 12 is configured for being engaged with a displacement device of a carpet stretching apparatus. Preferably, but not necessarily, the displacement device engaging structure 12 is a cylindrical-shaped steel tube having an cavity 20 with closed end or necked-down portion thereby enabling a mating engagement structure of a displacement device (e.g., an elongated adjustable tube) to be fixedly engaged within the cavity 20. For example, the mating engagement structure of the displacement device bears against the closed end or the necked-down portion of the cavity 20. The tail block mounting structure 14 is configured for being securely engaged with the swivel joint attachment structure of the tail block 18. The swivel joint 16 is connected between the displacement device engaging structure 12 and the tail block mounting structure 14. As is discussed herein in greater detail, the swivel joint 16 enables the displacement device engaging structure 12 to pivot with respect to the tail block mounting structure 14 about a first pivot axis P1 and a second pivot axis P2. The first pivot axis P1 extends approximately perpendicular to the second pivot axis P2.

The swivel joint 16 includes a first yoke structure 22 (i.e., a first end portion), a second yoke structure 24 (i.e., a second end portion) and a linkage member 26. The first yoke structure 22 is fixedly attached to the displacement device engaging structure 12. The second yoke structure 24 is fixedly attached to the tail block mounting structure 14. The linkage member is a cross-shaped member pivotably connected between the first yoke structure 22 and the second yoke structure 24.

The first yoke structure pivots about the first pivot axis P1, which extends in approximately parallel orientation along longitudinal axis L1 of opposed first lugs 28 of the linkage member 26. The second yoke structure 24 pivots about the second pivot axis P2, which extends in approximately parallel orientation along longitudinal axis L2 of opposed second lugs 30 of the linkage member 26. Each one of the opposed first lugs 28 of the linkage member 28 is pivotably engaged with a respective leg of the first yoke structure 22 and each one of the opposed second lugs 30 of the linkage member 28 is pivotably engaged with a respective leg of the second yoke structure 24 The first pivot axis P1 extends approximately perpendicularly through the second pivot axis P2 in that the opposed first lugs 28 of the linkage member 26 are oriented in a 90-degree rotation with respect to the opposed second lugs 30 of the linkage member 26. The first pivot axis P1 extends approximately perpendicular with respect to a longitudinal reference axis L3 of the displacement device engaging structure 12 and wherein the second pivot axis extends approximately perpendicular with respect to a longitudinal reference axis L4 of the tail block mounting structure 14. For clarity, in one embodiment of the present invention, the swivel joint 16 is similar in underlying construction and operation as a universal joint whose construction and operation is well-known in automotive and machinery arts.

The tail block 18 includes an engagement face 32 has a contoured profile. The contoured profile includes a plurality of step formations 34 extending linearly across an entire width W of the tail block 18. The step formations 34 are provided and intended for enabling relatively flush and substantial engagement with a baseboard of a wall (i.e., an immovable structure).

A layer of compliant material 36 is attached to the engagement face 32. A felt pad, foam pad, leather pad and the like are examples of the layer of compliant material 36. Preferably, but not necessarily, the layer of compliant material 36 is removable and/or replaceable. The layer of compliant material 36 serves to prevent topical damage (e.g., abrasions and scratches) to finished surfaces of an engaged immovable structure.

Still referring to FIGS. 1 and 2, the tail block mounting structure 14 bears against (i.e., is engaged with) a mounting plate 38 of the tail block 18. As depicted in FIG. 2, the tail block mounting structure 14 includes a threaded stud 40 (i.e., a tail block mounting member) that extends through an aperture 42 in the mounting plate 38. The stud 40 is accessible within a recessed portion 44 through a corresponding opening in the engagement face 32 of the tail block 18. A wind nut 46 (i.e., a mating threaded fastener) engages the threaded stud 40 for securing the tail block 18 in position with respect to the tail block mounting structure 14.

The displacement device engaging structure 12, the tail block mounting structure 14, the multi-axis swivel joint 16 (i.e., the swivel joint 16) and the threaded stud 40 jointly represent an embodiment of a swivel joint assembly in accordance with the present invention. Such a swivel joint assembly is configured for being attached to a tail block in accordance with the present invention. For example, such a swivel joint assembly is configured for being attached to the tail block 18 depicted in FIGS. 1 and 2.

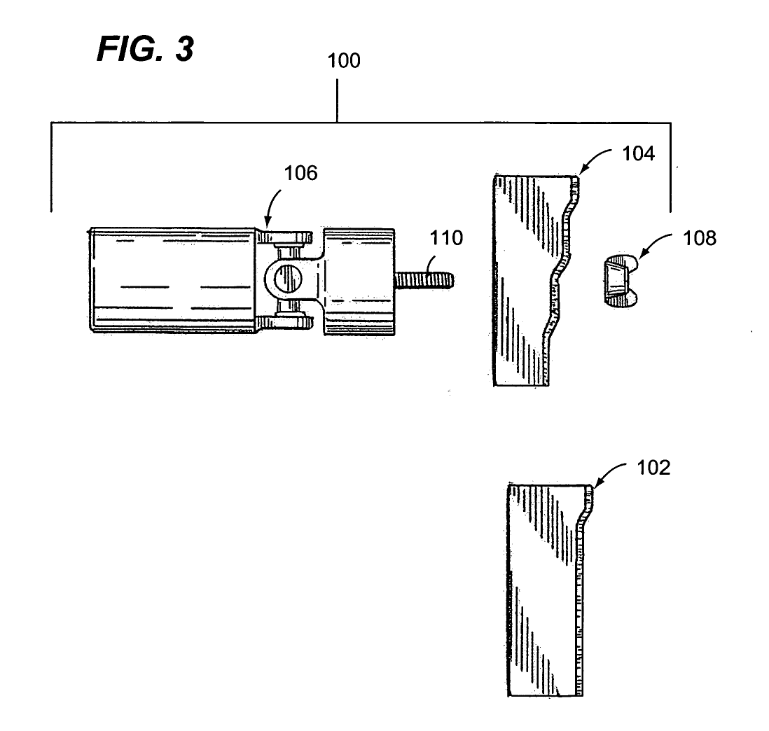

Referring now to FIG. 3, an embodiment of a tail block system in accordance with the present invention is depicted, which is referred to herein as the tail block system 100. The tail block system 100 includes a plurality of tail blocks (102, 104) and a multi-axis swivel joint assembly 106 (i.e., the swivel joint assembly 106). The overall construction and function of the swivel joint assembly 106 and the tail block (102, 104) are essentially the same as that of the swivel joint assembly and tail block disclosed above in reference to FIGS. 1 and 2.

Each one of the tail blocks (102, 104) has a swivel joint attachment structure as discussed above in reference to FIG. 2. More specifically, the swivel joint attachment structure includes a mounting plate, an aperture in the mounting plate and a recessed portion accessible through a corresponding opening in a respective engagement face of each one of the tail blocks (102, 104). A threaded fastener 108 (e.g., a nut) engages a mating threaded portion 110 (e.g., a stud) of the swivel joint assembly 106 for enabling each one of the tail block (102, 104) to be secured in position with respect to the swivel joint assembly 106.

The engagement face of each one of the tail blocks (102, 104) has a respective unique profile. For example, a first tail block 102 has a contoured profile including a single step formation extending linearly across an entire width thereof and a second tail block 104 has a contoured profile including a plurality of step formations extending linearly across an entire width thereof. The number of step formations corresponds to the number of transitions an engaged structure has (e.g., transitions from the bottom of a baseboard to an adjacent wall). It is disclosed herein that the size, spacing and number of step formations may be varied as useful for specific applications and/or for facilitating a preferred manner of engaging respective engagement face contours of different immovable structures. Additionally, a contoured profile may be a flat profile or a profile including a contour other than one or more step formations (e.g., arcuate shaped formations).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A tail block assembly for a carpet stretching apparatus, comprising:
a tail block mounting structure;
a displacement device engaging structure; and
a multi-axis swivel joint connected between the tail block mounting structure and the displacement device engaging structure, wherein the multi-axis swivel joint enables the displacement device engaging structure to pivot with respect to the tail block mounting structure about two approximately perpendicular pivot axes.

2. The tail block assembly of claim 1, further comprising:
a tail block including an engagement face having a contoured profile, wherein the tail block is attached to the tail block mounting structure.

3. The tail block assembly of claim 2 wherein the contoured profile includes at least one step formation extending linearly across an entire width of the tail block.

4. The tail block assembly of claim 2 wherein:
the tail block mounting structure is engaged with a mounting plate of the tail block;
a tail block mounting member extends through the mounting plate; and
the tail block mounting member is accessible through an opening in the engagement face.

5. The tail block assembly of claim 2 wherein the tail block includes a compliant layer of material attached to the engagement face.

6. The tail block assembly of claim 1 wherein:
the multi-axis swivel joint has a first end portion attached to the displacement device engagement structure and a second end portion attached to the tail block mounting structure;
a first one of said approximately perpendicular pivot axes extends through a longitudinal reference of the displacement device engagement structure;
a second one of said approximately perpendicular pivot axes extends through a longitudinal reference axis of the tail block mounting structure; and
the first one of said approximately perpendicular pivot axes extends approximately perpendicularly through the second one of said approximately perpendicular pivot axes.

7. The tail block assembly of claim 1, further comprising:
a tail block including an engagement face having a contoured profile;
wherein the tail block mounting structure includes a tail block mounting member extending along a longitudinal reference axis of the tail block;
wherein the tail block mounting member extends through a mounting plate of the tail block;
wherein tail block mounting member is accessible through an opening in the engagement face of the tail block;
wherein the multi-axis swivel joint has a first end portion attached to the displacement device engagement structure and a second end portion attached to the tail block mounting structure;
wherein a first one of said approximately perpendicular pivot axes extends through a longitudinal reference of the displacement device engagement structure;
wherein a second one of said approximately perpendicular pivot axes extends through a longitudinal reference axis of the tail block mounting structure;
wherein the first one of said approximately perpendicular pivot axes extends approximately perpendicularly through the second one of said approximately perpendicular pivot axes;
wherein the contoured profile includes at least one step formation extending linearly across an entire width of the tail block; and
wherein the tail block includes a compliant layer of material attached to the engagement face.

8. A tail block assembly for a carpet stretching apparatus, comprising:
a tail block mounting structure;
a displacement device engaging structure; and
a multi-axis swivel joint including a first yoke structure fixedly attached to the displacement device engaging structure, a second yoke fixedly attached to the tail block mounting structure and a linkage member pivotably connected between the first yoke structure and the second yoke structure, wherein the first yoke structure pivots about a first pivot axis of the linkage member and the second yoke structure pivot about a second pivot axis of the linkage member, wherein the first pivot axis extends approximately perpendicularly through the second pivot axis, wherein the first pivot axis extends approximately perpendicular with respect to a longitudinal reference axis of the displacement device engaging structure and wherein the second pivot axis extends approximately perpendicular with respect to a longitudinal reference axis of the tail block mounting structure.

9. The tail block assembly of claim 8, further comprising:
a tail block including an engagement face having a contoured profile, wherein the tail block is attached to the tail block mounting structure.

10. The tail block assembly of claim 9 wherein the contoured profile includes at least one step formation extending linearly across an entire width of the tail block.

11. The tail block assembly of claim 9 wherein:
the tail block mounting structure is engaged with a mounting plate of the tail block;
a tail block mounting member extends through the mounting plate; and
the tail block mounting member is accessible through an opening in the engagement face.

12. The tail block assembly of claim 9 wherein the tail block includes a compliant layer of material attached to the engagement face.

13. The tail block assembly of claim 8, further comprising:
a tail block including an engagement face having a contoured profile;
wherein the contoured profile includes at least one step formation extending linearly across an entire width of the tail block;
wherein the tail block mounting structure is engaged with a mounting plate of the tail block;
wherein a tail block mounting member extends through the mounting plate;
wherein the tail block mounting member is accessible through an opening in the engagement face; and
wherein the tail block includes a compliant layer of material attached to the engagement face.

14. A tail block system, comprising:
a plurality of tail blocks each having a swivel joint attachment structure, wherein an engagement face of each one of said tail blocks has a respective unique profile;
a multi-axis swivel joint assembly including a tail block mounting structure configured for being securely engaged with the swivel joint attachment structure of each one of said tail blocks, a displacement device engaging structure configured for being engaged with a displacement device of a carpet stretching apparatus and a multi-axis swivel joint connected between the tail block mounting structure and the displacement device engagement structure, wherein the multi-axis swivel joint enables the displacement device engaging structure to pivot with respect to the tail block attachment structure about two approximately perpendicular pivot axes.

15. The tail block system of claim 14 wherein:
the contoured profile of a first one of said tail blocks includes at least one step formation extending linearly across an entire width thereof; and
the contoured profile of a second one of said tail blocks includes at least two step formations extending linearly across an entire width thereof.

16. The tail block system of claim 14 wherein:
the tail block mounting structure is engagable with a mounting plate of each one of said tail blocks;
a tail block mounting member is configured for extending through the mounting plate each one of said tail blocks; and
the tail block mounting member is accessible through an opening in the engagement face of each one of said tail blocks when the tail block mounting structure is engaged with the mounting plate of one of said tail blocks.

17. The tail block system of claim 14 wherein each one of said tail blocks includes a compliant layer of material attached to the respective engagement face thereof.

18. The tail block system of claim 14 wherein:
the multi-axis swivel joint has a first end portion attached to the displacement device engagement structure and a second end portion attached to the tail block mounting structure;
a first one of said approximately perpendicular pivot axes extends through a longitudinal reference of the displacement device engagement structure;
a second one of said approximately perpendicular pivot axes extends through a longitudinal reference axis of the tail block mounting structure; and
the first one of said approximately perpendicular pivot axes extends approximately perpendicularly through the second one of said approximately perpendicular pivot axes.

19. The tail block system of claim 18 wherein:
the contoured profile of a first one of said tail blocks includes at least one step formation extending linearly across an entire width thereof; and
the contoured profile of a second one of said tail blocks includes at least two step formations extending linearly across an entire width thereof.

20. The tail block system of claim 14 wherein:
the contoured profile of a first one of said tail blocks includes at least one step formation extending linearly across an entire width thereof;
the contoured profile of a second one of said tail blocks includes at least two step formations extending linearly across an entire width thereof;
the tail block mounting structure is engagable with a mounting plate of each one of said tail blocks;
a tail block mounting member is configured for extending through the mounting plate each one of said tail blocks;
the tail block mounting member is accessible through an opening in the engagement face of each one of said tail blocks when the tail block mounting structure is engaged with a mounting plate of one of said tail blocks;
each one of said tail blocks includes a compliant layer of material attached to the respective engagement face thereof;
the multi-axis swivel joint has a first end portion attached to the displacement device engagement structure and a second end portion attached to the tail block mounting structure;
a first one of said approximately perpendicular pivot axes extends through a longitudinal reference of the displacement device engagement structure;
a second one of said approximately perpendicular pivot axes extends through a longitudinal reference axis of the tail block mounting structure; and
the first one of said approximately perpendicular pivot axes extends approximately perpendicularly through the second one of said approximately perpendicular pivot axes.
